(19) United States
(12) Patent Application Publication
(10) Pub. No.: US 2024/0289869 A1
(43) Pub. Date: Aug. 29, 2024

(54) SYSTEM AND METHOD TO DYNAMICALLY INJECT MULTIPLE CHECKOUT CAPABILITIES

(71) Applicant: firmly Inc, Sammamish, WA (US)

(72) Inventors: Kumar N Senthil, Sammamish, WA (US); Muralidharan Krishnamurthy, Bellevue, WA (US); Romeu Palos de Gouvea, New Castle, WA (US)

(21) Appl. No.: 18/173,129

(22) Filed: Feb. 23, 2023

(51) Int. Cl. G06Q 30/0601; G06F 21/31; G06Q 50/00

(52) U.S. Cl. CPC G06Q 30/0643; G06F 21/31; G06Q 50/01

(57) ABSTRACT

A system and method to dynamically inject multiple checkout capabilities is provided. The system includes a redirecting module to provide a first checkout path or a second checkout path in response to a user clicking on an advertisement displayed in a source app. The system includes a generating module to dynamically inject a checkout widget code template in response to the user accessing a cart page, thereby replacing an existing checkout experience seamlessly. The system includes a rendering module to display a checkout page based on the context provided by the source app, the checkout page displays user information that is pre-filled, providing a speedy checkout experience. The system includes an intelligent coupon code module to fetch a desirable discount for the products and automatically apply the desirable discount. The system includes a payment module to determine and display desirable payment method automatically to complete the purchase of the products.

### FIELD OF INVENTION

Embodiments of the present disclosure relate to the field of e-commerce, and more particularly, a system and a method to dynamically inject multiple checkout capabilities.

### BACKGROUND

Online shopping with a merchant via electronic payment modes has been widely accepted by most merchants. Typically, a merchant may host a website and list all the products for sale. A consumer may browse the website to shop for his/her desired products. Subsequently, the consumer may select the desired product(s) and enter his/her shipping information and billing information on a checkout page from the merchant website. The consumer will then be submitted to a payment network for verification. Upon successful verification and payment, the merchant website may generate a confirmation page to the consumer showing a summary of the transaction.

Throughout the online shopping process, a customer experiences various manifestations of checkouts that promise a limited number of clicks. However, the checkout process is a series of steps that the customer needs to follow to purchase the products in the cart. The steps include, but are not limited to, initial checkout, login, billing information, shipping information, shipping method, preview order and payment confirmation. The process of filing up the required information to purchase the desire product(s) often takes more time. The need to input the information such as name, credit card, email address, delivery location and contact number creates a delay that may be frustrating for customers. The need to create a password or remember a password is also a source of frustration of prospective customers. The checkout process becomes even more tedious and frustrating when the customers repeat the steps at every merchant website. Further, it can be very inconvenient for the customers to complete the transaction in time for making online purchases during different types of online sales such as, the Big Billion Day sale, the Black Friday sale, the End of Season sale, the Festival oriented sale and so on, where the merchants provide various online offers and discounts on their products and services for specific number of days or for specific number of hours per day.

Hence, there is a need for an improved system and method for dynamically injecting multiple checkout capabilities which addresses the aforementioned issue(s).

### BRIEF DESCRIPTION

In accordance with an embodiment of the present disclosure, a system to dynamically inject multiple checkout capabilities is provided. The system includes a processing subsystem hosted on a server. The processing subsystem is configured to execute on a network to control bidirectional communications among a plurality of modules. The processing subsystem includes a redirecting module configured to provide one of a first checkout path and a second checkout path to the user, in response to the user clicking on an advertisement displayed in a source app. The first checkout path is adapted to enable the user to configure one or more options for one or more products and purchase the one or more products within the context of the advertisement or an offer displayed in the source app. The second checkout path is adapted to redirect the user to a merchant's website and allow the user to view one or more products prior to the purchase of the said one or more products, wherein the second checkout path is within one of the context of the advertisement displayed in the source app and within the context of the source app. The processing subsystem includes a generating module operatively coupled to the redirecting module wherein the generating module is configured to dynamically inject a checkout widget code template which is templatized based on the context of the source app, user and merchant's website for a streamlined checkout experience in response to the user accessing the cart page wherein the checkout widget code template replaces an existing checkout experience seamlessly. Further, the processing subsystem includes a rendering module operatively coupled to the generating module wherein the rendering module is configured to display a checkout page based on the context provided by the source app in response to the user selecting the checkout button integrated with the checkout widget code template, wherein the checkout page displays user information that is pre-filled thereby providing a speedy checkout experience to the user. Furthermore, the processing subsystem includes an intelligent coupon code module configured to fetch a desirable discount for the one or more products and automatically apply the desirable discount to a metadata corresponding to a profile of the user. Moreover, the processing subsystem includes a payment module configured to determine and display a desirable payment method to the user automatically to complete the purchase of the one or more products in the merchant website wherein the desirable payment method provides additional benefits as part of the purchase to the user.

In accordance with an embodiment of the present disclosure, a method to dynamically inject multiple checkout capabilities is provided. The computer-implemented method includes providing, by a redirecting module of a processing subsystem, one of a first checkout path and a second checkout path to a user, in response to the user clicking on an advertisement displayed in a source app. The first checkout path is adapted to enable the user to configure one or more options for one or more products and purchase the one or more products within the context of the advertisement or an offer displayed in the source app. The second checkout path is adapted to redirect the user to a merchant's website and allow the user to view one or more products prior to the purchase of the said one or more products wherein the second checkout path is within one of the context of the advertisement displayed in the source app and within the context of the source app. The computer-implemented method includes injecting, by a generating module of the processing subsystem, dynamically inject a checkout widget code template which is templatized based on the context of the source app, user and merchant's website for a streamlined checkout experience in response to the user accessing the cart page wherein the checkout widget code template replaces an existing checkout experience seamlessly. Further, the computer-implemented method includes displaying, by a rendering module of the processing subsystem, a checkout page based on the context provided by the source app in response to the user selecting the checkout button integrated with the checkout widget code template, wherein the checkout page displays user information that is pre-filled thereby providing a speedy checkout experience to the user. Furthermore, computer-implemented the method includes fetching, by an intelligent coupon code of the processing subsystem, desirable discount for the one or more products and automatically apply the desirable discount to a metadata corresponding to a profile of the user. Moreover, the computer-implemented method includes determining and displaying, by a payment module of the processing subsystem, a desirable payment method to the user automatically to complete the purchase of the one or more products in the merchant website wherein the desirable payment method provides additional benefits as part of the purchase to the user.

In accordance with another embodiment of the present disclosure, a non-transitory computer-readable medium storing a computer program that, when executed by a processor, causes the processor to perform a computer-implemented method to dynamically inject multiple checkout capabilities is provided. The computer-implemented method includes providing, by a redirecting module of a processing subsystem, one of a first checkout path and a second checkout path to a user, in response to the user clicking on an advertisement displayed in a source app. The first checkout path is adapted to enable the user to configure one or more options for one or more products and purchase the one or more products within the context of the advertisement or an offer displayed in the source app. The second checkout path is adapted to redirect the user to a merchant's website and allow the user to view one or more products prior to the purchase of the said one or more products wherein the second checkout path is within one of the context of the advertisement displayed in the source app and within the context of the source app. The computer-implemented method includes injecting, by a generating module of the processing subsystem, dynamically inject a checkout widget code template which is templatized based on the context of the source app, user and merchant's website for a streamlined checkout experience in response to the user accessing the cart page wherein the checkout widget code template replaces an existing checkout experience seamlessly. Further, the computer-implemented method includes displaying, by a rendering module of the processing subsystem, a checkout page based on the context provided by the source app in response to the user selecting the checkout button integrated with the checkout widget code template, wherein the checkout page displays user information that is pre-filled thereby providing a speedy checkout experience to the user. Furthermore, computer-implemented the method includes fetching, by an intelligent coupon code of the processing subsystem, desirable discount for the one or more products and automatically apply the desirable discount to a metadata corresponding to a profile of the user. Moreover, the computer-implemented method includes determining and displaying, by a payment module of the processing subsystem, a desirable payment method to the user automatically to complete the purchase of the one or more products in the merchant website wherein the desirable payment method provides additional benefits as part of the purchase to the user.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to dynamically inject multiple checkout capabilities in accordance with an embodiment of the present disclosure;

FIG. 2 is a schematic representation of an exemplary embodiment of a system to dynamically inject multiple checkout capabilities of FIG. 1 in accordance with an embodiment of the present disclosure;

FIG. 3 is a block diagram of a computer or a server in accordance with an embodiment of the present disclosure;

FIG. 4 is a schematic representation of multiple checkout capabilities in accordance with an embodiment of the present disclosure;

FIG. 5 is a schematic representation of a seller integration in accordance with an embodiment of the present disclosure; and

FIG. 6 illustrates a flow chart representing the steps involved in a method for dynamically injecting multiple checkout capabilities in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In accordance with an embodiment of the present disclosure, a system to dynamically inject multiple checkout capabilities is provided. The system includes a processing subsystem hosted on a server. The processing subsystem is configured to execute on a network to control bidirectional communications among a plurality of modules. The processing subsystem includes a redirecting module configured to provide one of a first checkout path and a second checkout path to the user, in response to the user clicking on an advertisement displayed in a source app. The first checkout path is adapted to enable the user to configure one or more options for one or more products and purchase the one or more products within the context of the advertisement or an offer displayed in the source app. The second checkout path is adapted to redirect the user to a merchant's website and allow the user to view one or more products prior to the purchase of the said one or more products, wherein the second checkout path is within one of the context of the advertisement displayed in the source app and within the context of the source app. The processing subsystem includes a generating module operatively coupled to the redirecting module wherein the generating module is configured to dynamically inject a checkout widget code template which is templatized based on the context of the source app, user and merchant's website for a streamlined checkout experience in response to the user accessing the cart page wherein the checkout widget code template replaces an existing checkout experience seamlessly. Further, the processing subsystem includes a rendering module operatively coupled to the generating module wherein the rendering module is configured to display a checkout page based on the context provided by the source app in response to the user selecting the checkout button integrated with the checkout widget code template, wherein the checkout page displays user information that is pre-filled thereby providing a speedy checkout experience to the user. Furthermore, the processing subsystem includes an intelligent coupon code module configured to fetch a desirable discount for the one or more products and automatically apply the desirable discount to a metadata corresponding to a profile of the user. Moreover, the processing subsystem includes a payment module configured to determine and display a desirable payment method to the user automatically to complete the purchase of the one or more products in the merchant website wherein the desirable payment method provides additional benefits as part of the purchase to the user.

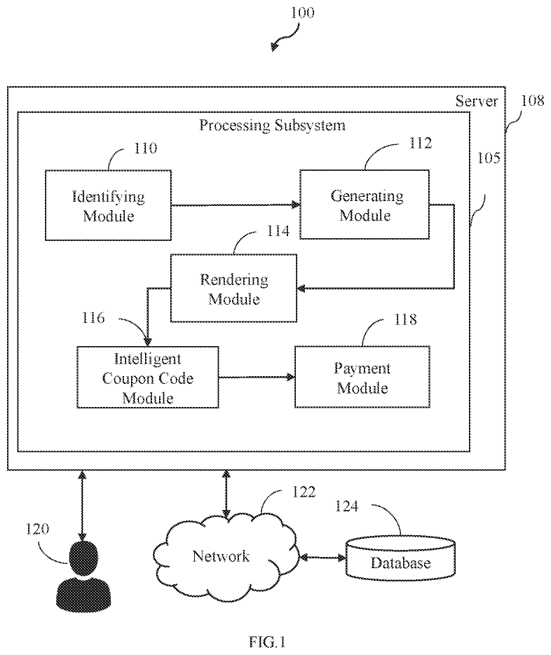

FIG. 1 is a block diagram representation of a system to dynamically inject multiple checkout capabilities in accordance with an embodiment of the present disclosure.

The system 100 includes a processing subsystem 105 hosted on a server 108. In one embodiment, the server 108 may include a cloud-based server. In another embodiment, parts of the server 108 may be a local server. The processing subsystem 105 is configured to execute on a network 122 to control bidirectional communications among a plurality of modules. In one example, the network 122 may be a private or public local area network (LAN) or Wide Area Network (WAN), such as the Internet. In another embodiment, the network 122 may include both wired and wireless communications according to one or more standards and/or via one or more transport mediums. In one example, the network 122 may include wireless communications according to one of the 802.11 or Bluetooth specification sets, or another standard or proprietary wireless communication protocol. In yet another embodiment, the network 122 may also include communications over a terrestrial cellular network, including, a global system for mobile communications (GSM), code division multiple access (CDMA), and/or enhanced data for global evolution (EDGE) network.

The processing subsystem 105 includes an identifying module 110 to determine a user 220 accessing a cart page via a source app to purchase one or more products corresponding to a merchant website. The source app provides a platform for ecommerce tools to help merchants sell more products directly from their respective social pages. Examples of the source app includes, but are not limited to, Facebook, Twitter, Instagram, Pinterest, WhatsApp, CapitalOne Shopping, Chase Offers, Amex Offers and so on. Typically, a customer who visits the source app can tap or click on a view shop button to see products, add products to their cart page and purchase them directly from a checkout page.

The processing subsystem 105 includes a generating module 112 operatively coupled to the identifying module 110. The generating module 112 is configured to dynamically inject a checkout widget code template for a checkout widget at a moment when the user 220 accesses the cart page. The checkout widget code template is typically a script for a checkout page that replaces an existing checkout experience by the source app. It is to be noted that the replacement of the checkout widget code template is automatically and seamlessly executed based on the context of the source app, user 220 and merchant's website/app. The checkout widget code template now allows the user 220 to place an order of his/her desired product(s) from the generated checkout page (hereinafter referred to as ‘XXXX Checkout page’, wherein the ‘XXXX’ represents a context pertaining to the source app).

The processing subsystem 105 also includes a rendering module 114 to display the XXXX Checkout page based on the context provided by the source app in response to the user 220 clicking the checkout token. It must be noted that the checkout widget code template is configured to provide dual checkout capabilities to the user 220. The dual checkout capabilities are listed as below: 1. Approach 1: Allows the user 220 to directly purchase the one or more products from the merchant website. 2. Approach 2: Allows the user 220 to visit the merchant website and continue to view the one or more products prior to purchase of the said one or more products.

In both the cases, the checkout experience will be the same for the user 220.

In one embodiment, Approach 1 and Approach 2 are merged to form a ‘hybrid approach’ (hybrid checkout capability). In such an embodiment, the hybrid checkout capability is subjected to render details of the one or more products and allow the user 220 to visit the merchant website.

The processing subsystem 105 further includes an intelligent coupon code module 116 configured to fetch a desirable discount for the one or more products that the user 220 is interested to purchase. The desirable discount may be defined as the best discount offered to the user 220. It must be noted the desirable discount is automatically applied to a metadata corresponding to a profile of the user 220.

Furthermore, the processing subsystem 105 includes a payment module 118 to determine and display a desirable payment method to the user 220. Yet again, the desirable payment method may be defined as the best payment mode offered to the user 220. The user 220 may select the desirable payment method to complete the purchase of the one or more products in the merchant website.

In one embodiment, the various functional components of the system may reside on a single computer, or they may be distributed across several computers in various arrangements. The various components of the system may, furthermore, access one or more databases, and each of the various components of the system may be in communication with one another. Further, while the components of FIG. 1 are discussed in the singular sense, it will be appreciated that in other embodiments multiple instances of the components may be employed.

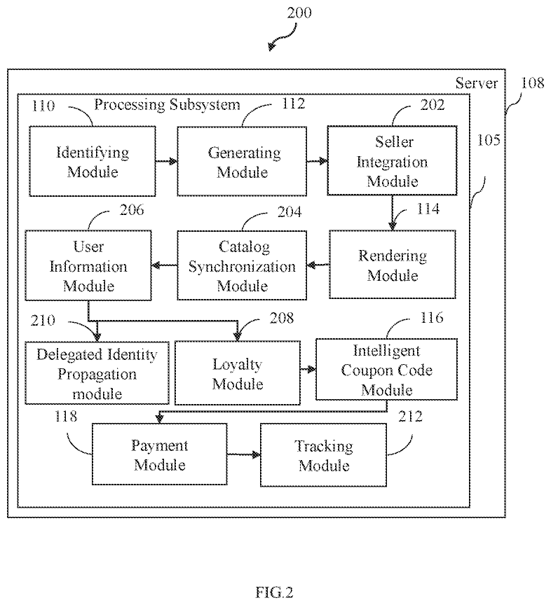

FIG. 2 is a schematic representation of an exemplary embodiment of a system to dynamically inject multiple checkout capabilities of FIG. 1 in accordance with an embodiment of the present disclosure. Considering a non-limiting example in which a user 120 browses a source app on his/her corresponding user device through a web browser. Examples of the user device include, but is not limited to, a mobile phone, desktop computer, portable digital assistant (PDA), smart phone, tablet, ultra-book, netbook, laptop, multi-processor system, microprocessor-based or programmable consumer electronic system, or any other communication device that a user 120 may use. In some embodiments, the system may comprise a display module (not shown) to display information (for example, in the form of user interfaces). In further embodiments, the system may comprise one or more of touch screens, accelerometers, gyroscopes, cameras, microphones, global positioning system (GPS) devices, and so forth. Further, example of the web browser includes, but is not limited to, Microsoft Edge, Internet Explorer, Google Chrome, Mozilla Firefox and Apple Safari.

As the user 120 browses the social application to look for content that may be inspiring or entertaining, small business advertisements can be shown to the user 120 (typically known as social media advertising). These advertisements may be subjected to products listed in a corresponding merchant's website. When the user 120 clicks on a particular advertisement, will be presented with product details, price, images, ability to choose the configuration of the product for instance, size, color etc. Besides that, the user 120 will be presented with two options. A “Buy Now” option which allows the customer to checkout without going to the merchant's website. A “Visit Website” option will redirect the user 120 to the merchant's website. A cart page on the merchant's website is identified by an identifying module 110. At this point, a checkout widget code template is dynamically injected into an existing checkout experience in the merchant's website/app. The replacement takes place automatically and seamlessly by a generating module 112. A seller integration module 202 is operatively coupled to the generating module 112. Further, the seller integration module 202 is configured to automatically validate the merchant website and activate the checkout widget code template in response to successful validation. The seller integration module 202 detects one or more changes on the merchant website automatically to render the details of the one or more products corresponding to the one or more changes and integrate seamlessly with the checkout capabilities of the merchant website. As a result, a checkout page is displayed based on the context provided by the source app by a rendering module 114. The checkout page configured with the checkout widget code template is adapted to provide intelligent checkout capability to the user 120. When the cart page is displayed to the user 120, the checkout widget code template is injected automatically thereby replacing the existing checkout experience with “Checkout with XXXX” button. When the user 120 clicks the “Checkout with XXXX” button, the checkout widget code template will launch the checkout page associated with XXXX. It must be noted that the sequence ‘XXXX’ represents the context of the source app visited by the user 120. In both the cases the checkout experience will be the same for the user 120. A catalog synchronization module 204 is configured to fetch the content, inventory and pricing from the merchant's Product Detail Page (PDP) and are displayed to the user 120. All necessary information related to the checkout is then passed on the checkout page by the user information module 206 to complete the order via alternative forms of payments (AFOPs). Typically, the user information module 206 is configured to prepopulate user details wherein the user details are fetched from previous check out pages completed by the user on various other merchant websites. The user details (or user information) is stored in a database 124 wherein the information is pre-populated in the checkout token based on the context.

A loyalty module 208 is configured to accumulate loyalty points offered to the user 120 by the other merchant websites over time. In one embodiment, promo codes that are offered to the user 120 may be fetched to avail a discounted price when purchasing products.

In another embodiment, if the merchant's website supports a social media login for a user 120, then the user's email id may be sent to the loyalty module. Discounts, promo codes and loyalty points associated to the user's email id may then be offered at the time of purchasing products. However, if the merchant's website for some reason does not support the social media login, then a username, and a certificate of authenticity is sent to the loyalty module. Upon verification of the said username, password and certificate of authenticity, one or more benefits are provided to the user 120 at the time of purchasing products.

A delegated identity propagation module 210 operatively coupled to the user information module 206 wherein the delegated identity propagation module 210 is configured to integrate with the merchant's website to seamlessly provide a logged in checkout experience to the user 120 by validation thereby discarding the need of the user 120 to log in multiple times during checkout.

In one embodiment, the delegated identity propagation module 210 may support social login of the user 120. In such an embodiment, consider a scenario wherein the user 120 has an account with the social or OAUTH identity provider, for instance Google, Facebook, Microsoft, Tik Tok, Snap chat and the like, and the user 120 is logged into the source app using the said identity. In such a scenario, the delegated identity propagation module 210 would provide a username (for instance, an email address) and a validated secure identity token (or certificate) that the merchant would trust and allow the user 120 to continue as an authenticated user 120 for the said username. Alternatively, if the user 120 already has an account for the said username, then the merchant's website is configured to automatically provide an authenticated session token for that user profile or a new user profile is created and subsequently the session token will be provided to the user 120.

In another embodiment, the delegrated identity propagation module 210 may not support social login of the user 120. In such an embodiment, the delegated identity propagation module 210 will provide email address or phone number obtained from the identity provider to the merchant and the merchant could send a one time passcode (OTP) to the said email address or phone number. Once the user 120 applies the OTP to authenticate the said email address or phone number, then the merchant would provide an authenticated session token that will be used for the transaction. Therefore, this discards the need of the user 120 to remember his/her password across multiple merchant websites while shopping from the source app.

An intelligent coupon code module 116 is configured to fetch a desirable discount for the one or more products and automatically apply the desirable discount to a metadata corresponding to a profile of the user 120.

A payment module 118 supports multiple payment methods to the user 120 and allows the user 120 to purchase an insurance, in response to the user 120 purchasing the one or more products within the context of the source app.

A tracking module 210 is configured to track the status of the order placed by the user 120.

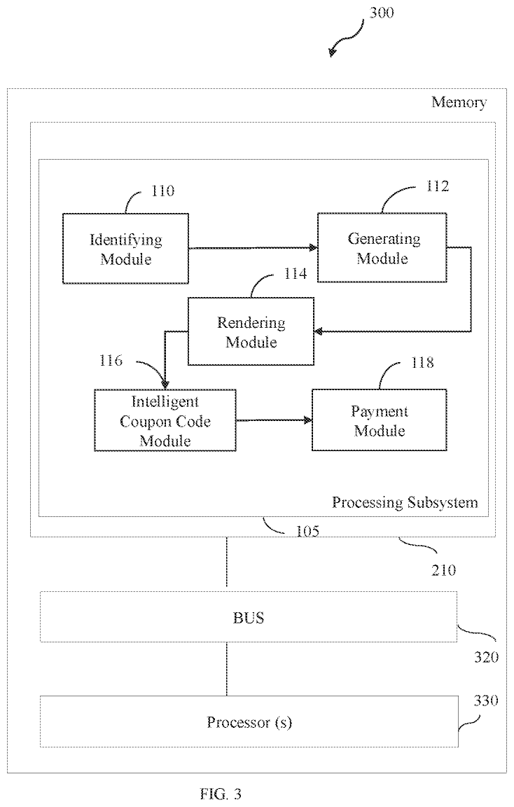

FIG. 3 is a block diagram of a computer or a server in accordance with an embodiment of the present disclosure. The server 108 includes processor(s) 330, and memory 310 operatively coupled to the bus 320. The processor(s) 330, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 310 includes several subsystems stored in the form of computer-readable medium which instructs the processor to perform the method steps illustrated in FIG. 1. The memory 310 includes several subsystems stored in the form of executable program which instructs the processor 330 to perform the method steps illustrated in FIG. 1. The memory 310 includes a processing subsystem 105 of FIG. 1. The processing subsystem 105 further has following modules: an identifying module 110, a generating module 112, a rendering module 114, an Intelligent Coupon Code Module 116 and a Payment Module 118.

In accordance with an embodiment of the present disclosure, a system to dynamically inject multiple checkout capabilities is provided. The system includes a processing subsystem hosted on a server. The processing subsystem is configured to execute on a network to control bidirectional communications among a plurality of modules. The processing subsystem includes an identifying module configured to determine a user 120 accessing a cart page via a source app to purchase one or more products corresponding to a merchant website. Further, the processing subsystem includes a generating module operatively coupled to the identifying module and configured to dynamically inject a checkout widget code template for a checkout token in response to the user 120 accessing a cart page wherein the checkout widget code template replaces an existing checkout experience seamlessly based on a context provided by the source app. Furthermore, the processing subsystem includes a rendering module to display a checkout page based on the context provided by the source app in response to the user 120 selecting the checkout token integrated with the checkout widget code template and wherein the checkout widget code template is configured to provide dual checkout capabilities to the user 120. The processing subsystem also includes an intelligent coupon code module configured to fetch a desirable discount for the one or more products and automatically apply the desirable discount to a metadata corresponding to a profile of the user 120. The processing subsystem also includes a payment module configured to determine and display a desirable payment method to the user 120 to complete the purchase of the one or more products in the merchant website.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The bus (220) as used herein refers to be internal memory channels or computer network that is used to connect computer components and transfer data between them. The bus (220) includes a serial bus or a parallel bus, wherein the serial bus transmits data in bit-serial format and the parallel bus transmits data across multiple wires. The bus (220) as used herein, may include but not limited to, a system bus, an internal bus, an external bus, an expansion bus, a frontside bus, a backside bus and the like.

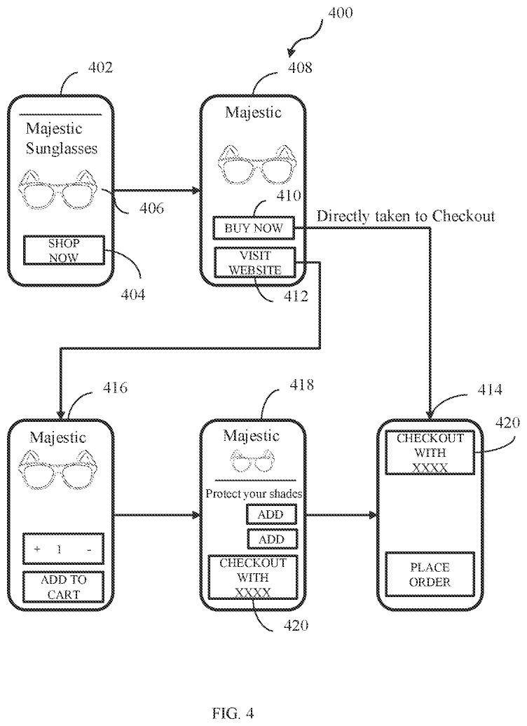

FIG. 4 is a schematic representation of multiple checkout capabilities in accordance with an embodiment of the present disclosure. As mentioned earlier, as the user 120 browses a particular source app 402, an advertisement is displayed to a user 120 along with an option 404 to shop for a product. The advertisement may relate to the promotion of a product, for example a sunglass 406. When the user 120 clicks on the option 404, the user 120 is directed to a page 408 that provides two options namely “Buy now” 410 and “Visit website” 412.

When the user 120 clicks “Buy now” option 410, the user 120 is directly taken to a checkout page 414. In this direction, the user 120 can checkout with the context corresponding to the source app. For instance, if the user 120 was browsing on Facebook, the checkout will also be executed with the context of Facebook. At this point, the merchant's checkout token is replaced with the “Checkout with XXXX” via the checkout widget code template 420. Alternative forms of payments (AFOPs) will be supported to allow the user 120 to complete the transaction. This option is the first approach of the present disclosure. It must be noted that in the first approach, the user 120 does visit the merchant's website.

When the user 120 clicks on “Visit website” option 412, the user 120 is redirected to the merchant's website 416. The user 120 may add products to the cart 418. At this point, the merchant's checkout token is replaced with the “Checkout with XXXX” via the checkout widget code template 420 via the social widget code template. This option is the second approach of the present disclosure.

It must be noted that the present disclosure may merge the first approach and the second approach to represent a “hybrid approach”.

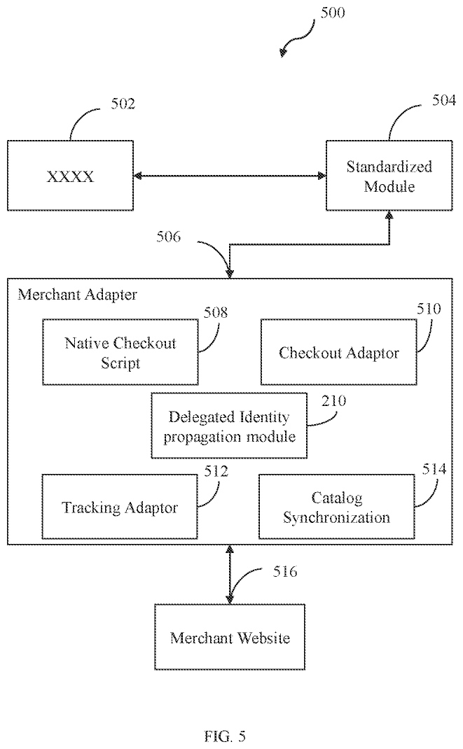

FIG. 5 is a schematic representation of a seller integration in accordance with an embodiment of the present disclosure. A user 120 visits a source app XXXX 502.

Typically, a merchant adapter 506 is a component that is built and integrated in a merchant's website 516. The merchant adapter 506 is adapted as a standardized module 504 so that it can be easily reassembled or rearranged into different functional forms or shared across different platforms. The merchant adapter 506 comprises a native checkout script 508, a checkout adapter 510, a delegated identity propagation module 210, a tracking adaptor 512 and a catalog synchronization 514.

The native checkout script 508 gets injected in the checkout page thereby changing the behavior of the checkout. Additional responsibilities of the native checkout script 508 includes identifying a cart page via an associated Universal Resource Locator (URL), developing the checkout widget code template that replaces the existing checkout experience, developing a script to read the cart items and develop a script to launch the source app checkout page while forwarding the necessary information for checkout process.

The checkout adapter 510 is accountable to help place the order in the merchant's website. Typically, the role of the checkout adapter 510 is to manage the cart, set shipping address, set delivery method and finally place the order.

The catalog synchronization 514 is accountable to fetch a plurality of products (catalog) listed from the merchant's website. Typically, the content that includes price and inventory details are scraped form the merchant's website. The catalog synchronization 514 is required only for approach 2 and the hybrid approach as disclosed herein.

The delegated identity propagation module 210 is configured to integrate with the merchant's website to seamlessly provide a logged in checkout experience to the user 120 by validation thereby discarding the need of the user 120 to log in multiple times during checkout.

The tracking adaptor 512 allows the user 120 to track an order placed for a particular product. The relevant page is scraped to get information associated with the order. In one embodiment, if the merchant's website uses an Application Programming Interface (API), then the order status may be pulled from it.

In one embodiment, the seller integration occurs seamlessly and requires zero to minimal effort from the respective merchant. This increases the scalability rate.

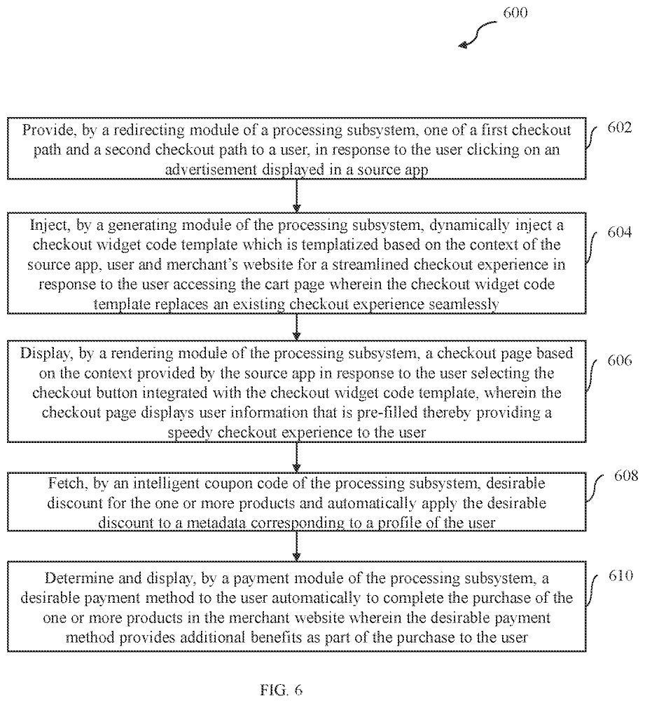

FIG. 6 illustrates a flow chart representing the steps involved in a method for dynamically injecting multiple checkout capabilities in accordance with an embodiment of the present disclosure. The user visits a source app “XXXX” and browses through while one or more advertisements are displayed to the user. The user clicks on a particular advertisement. The method begins at step 602.

At step 602, a first checkout path and a second checkout path to the user, in response to the user clicking on an advertisement displayed in a source app. The first checkout path is adapted to enable the user to configure one or more options for one or more products and purchase the one or more products within the context of the advertisement or an offer displayed in the source app. The second checkout path is adapted to redirect the user to a merchant's website and allow the user to view one or more products prior to the purchase of the said one or more products. Specifically, the second checkout path is within one of the context of the advertisement displayed in the source app and within the context of the source app.

The first checkout path and the second checkout path are merged to provide a third checkout path wherein the third checkout path provides a dual checkout capability to the user, in response to the user clicking the advertisement displayed in the source app.

Further, the user accessing a cart page via a source app is identified. The user may want to purchase one or more products corresponding to a merchant website. In one embodiment, the details of the one or more products is rendered to the user and subsequently the user is allowed to visit a corresponding merchant website.

In one embodiment, fetch content, inventory and pricing of the products displayed to the user by a catalog synchronization module.

Generally, the user ends up buying other items than what they would have initially seen on the advertisement. To avoid this scenario, the method described herein aims to improve the conversion and also keep the user to browse within the context of the “XXXX” properties. Therefore, in one embodiment, the method is adapted to render with a plurality of browsing features to confine the user to pay attention to a pre-defined number of products to purchase. In such an embodiment, the pre-define number of products may be generated through a “micro browse”, “mini browse” and “maxi browse” features as listed below:
a. Micro Browse: this feature allows “XXX)X” to display up to 4 products from the merchant's website in response to the user clicking on an advertisement. This increases the chances of the user to buy a product within the displayed 4 products.
b. Mini Browse: this feature allows “XXXX” to display up to 100 products from the merchant's website in response to the user clicking on an advertisement. This verifies that the user can browse and transact within “XXXX” an extensive number of products are displayed. This feature is deemed to be vital in light of the present disclosure and can be implemented for several marketplaces, shops and metaverse/Roblox. Further, this feature eliminates the need of the merchants to manage their respective store separately with fulfillment, returns, refunds and so on in addition to the integration.
c. Maxi Browse: this feature redirects the user to the merchant's website thereby allowing the user to browse across all the products and subsequently purchase from the merchant's website.

It must be noted that the aforementioned features may be integrated with any of the approaches provided by the method disclosed herein. The approaches being a first approach, a second approach and a hybrid approach.

Further, identifying a cart page initiates an onboarding process that executes a script to read the cart items. In one embodiment, finger printing of the source app is monitored to note the changes to the associated web page after the onboarding process.

At step 604, a checkout widget code template is dynamically injected wherein the checkout widget code template is templatized based on the context of the source app, user and merchant's website for a streamlined checkout experience. It must be noted that the checkout widget code is dynamically injected in response to the user accessing the cart page wherein the checkout widget code template replaces an existing checkout experience seamlessly.

This results in replacement of the existing checkout widget with the new “Checkout with XXXX” button seamlessly and automatically. In one embodiment, the “XXXX” represents the context of the source app.

The injection of the checkout token takes place between 3 different approaches:
a. A first approach: Takes place when the user clicks on “Buy Now” option. At this point, the user can checkout within the source app “XXXX” properties. Here, the user will not go to the merchant's website. The injected social media widget template will fetch the products information and is rendered in the source app itself so that the user can check out in the source app itself. A cart will be dynamically created and managed from the source app and when the user does the checkout from the source app, the system will seamlessly pump the order into the merchant's website either via an API or filling the form automatically.
b. A second approach: Takes place when the user clicks on the “Go to Website” option. At this point, the user is redirected from the source app “XXXX” page to the corresponding merchant's website. When the user gets to the cart page of the merchant's website, the existing checkout buttons will be seamlessly replaced during the loading of the cart page. Subsequently, when the user clicks on the checkout button dynamically injected by the checkout widget, it will launch the XXXX checkout page. From here, the user may place the order of desired product(s). The injected social media widget template will fetch the products in the cart and other necessary information to place the order.
c. A hybrid approach: Takes place when both the first approach and second approach is displayed to the user.

In one embodiment, the checkout widget code template is adapted with a unique feature of self-healing to overcome a failure. The self-healing is a process wherein a fault is automatically detected on the merchant's website. The fault may correspond to an error in execution. Upon detecting, the checkout widget code template fixes the fault automatically. In one embodiment, an alert may be raised at the occurrence of a failure. In such an embodiment, a recover script may be executed at the merchant's website to fix the fault.

In another embodiment, the merchant website is automatically validated and the checkout widget code template is activated in response to successful validation by a seller integration module. The seller integration module is operatively coupled to the generating module.

Further, the one or more changes are detected automatically on the merchant website to render the details of the one or more products corresponding to the one or more changes. Furthermore, the seller integration module is integrated seamlessly with the checkout capabilities of the merchant website.

In one embodiment, the seller integration module is configured to activate and deactivate a self-healing process in occurrence of an error in the merchant website.

At step 606, a checkout page is displayed based on the context provided by the source app in response to the user selecting the checkout button integrated with the checkout widget code template. The checkout page displays user information that is pre-filled thereby providing a speedy checkout experience to the user.

A user information module is configured to prepopulate user details in response to the user selecting the checkout button. Further, the user details are fetched from previous check out pages completed by the user on multiple merchant websites within the context of the source app.

In one embodiment, the checkout button is adapted to change based on the context of the source app.

In one embodiment, the information of the user is stored in a database to store information of the user wherein the information is pre-populated in the checkout token based on the context of the source app.

Further, a delegated identity propagation module is operatively coupled to the user information module. The delegated identity propagation module is configured to integrate with the merchant's website. Consequently, a logged in checkout experience is provided seamlessly to the user by validation thereby discarding the need of the user to log in multiple times during checkout.

At step 608, a desirable discount is fetched for the one or more products and automatically apply the desirable discount to a metadata corresponding to a profile of the user.

The discount is automatically applied to a metadata corresponding to a profile of the user. The desirable discount represents the best discounts that are available to the user. In one embodiment, the discounts may be received through promo codes.

In one embodiment, loyalty points offered to the user by a plurality of merchant websites are accumulated by a loyalty module. The loyalty module is operatively coupled to the user information module.

In another embodiment, the loyalty points are redeemed by a user for subsequent payments.

At step 610, a desirable payment method is determined and displayed to the user automatically to complete the purchase of the one or more products in the merchant website wherein the desirable payment method provides additional benefits as part of the purchase to the user.

In one embodiment, the desirable payment method to the user is determined based on a success rate of previous payments made by the user and the previously used payment method of the user.

The payment method refers to a payment account that is used to fund the financial transaction to purchase the one or more products. Examples of the payment account include, but are not limited to a savings account, a credit account, a checking account and a virtual payment account. The payment account may be associated with an entity such as an individual person, a family, a commercial entity, a company, a corporation, a governmental entity, a non-profit organization and the like. In some scenarios, the payment account may be a virtual or temporary payment account that can be mapped or linked to a primary payment account, such as those accounts managed by digital wallet or other payment application.

In one embodiment, the payment module supports multiple payment methods to the user and allows the user to purchase an insurance, in response to the user purchasing the one or more products within the context of the source app.

In one embodiment, PayPal is supported as a payment method. In another embodiment, additional payment methods and wallets may be supported.

In one embodiment, orders placed by the user is tracked by a tracking module.

The method ends at step 610.

Various embodiments of the system and method for injecting multiple checkout capabilities provides several benefits. One such benefit is that the user experiences an easy and faster checkout process. This enhances the user experience of the checkout on the e-commerce application and customer satisfaction further promotes the sales on the merchant side. The method eliminates the need to fetch the user's details for placing the order and shipping. Further, the seamless onboarding of the merchant provides faster scalability.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown: nor do all of the acts need to be necessarily performed. Also, those acts that are not dependent on other acts may be performed in parallel with the other acts. The scope of embodiments is by no means limited by these specific examples.

We claim:

1. A system to dynamically inject multiple checkout capabilities comprising:
a processing subsystem hosted on a server, wherein the processing subsystem is configured to execute on a network to control bidirectional communications among a plurality of modules comprising:
a redirecting module configured to provide one of a first checkout path and a second checkout path to the user, in response to the user clicking on an advertisement displayed in a source app wherein,
the first checkout path is adapted to enable the user to configure one or more options for one or more products and purchase the one or more products within the context of the advertisement or an offer displayed in the source app; and
the second checkout path is adapted to redirect the user to a merchant's website and allow the user to view one or more products prior to the purchase of the said one or more products,
wherein the second checkout path is within one of the context of the advertisement displayed in the source app and within the context of the source app;
a generating module operatively coupled to the redirecting module wherein the generating module is configured to dynamically inject a checkout widget code template which is templatized based on the context of the source app, user and merchant's website for a streamlined checkout experience in response to the user accessing the cart page wherein the checkout widget code template replaces an existing checkout experience seamlessly;
a rendering module operatively coupled to the generating module wherein the rendering module is configured to display a checkout page based on the context provided by the source app in response to the user selecting the checkout button integrated with the checkout widget code template, wherein the checkout page displays user information that is pre-filled thereby providing a speedy checkout experience to the user;
an intelligent coupon code module configured to fetch a desirable discount for the one or more products and automatically apply the desirable discount to a metadata corresponding to a profile of the user; and
a payment module configured to determine and display a desirable payment method to the user automatically to complete the purchase of the one or more products in the merchant website wherein the desirable payment method provides additional benefits as part of the purchase to the user.

2. The system as claimed in claim 1 wherein the first checkout path and the second checkout path are merged to provide a third checkout path wherein the third checkout path provides a dual checkout capability to the user, in response to the user clicking the advertisement displayed in the source app.

3. The system as claimed in claim 1 comprising:
a user information module configured to prepopulate user details in response to the user selecting the checkout button wherein the user details are fetched from previous check out pages completed by the user on multiple merchant websites within the context of the source app.

4. The system as claimed in claim 1 comprising:
a delegated identity propagation module operatively coupled to the user information module wherein the delegated identity propagation module is configured to integrate with the merchant's website to seamlessly provide a logged in checkout experience to the user by validation thereby discarding the need of the user to log in multiple times during checkout.

5. The system as claimed in claim 4 wherein the delegated identity propagatioin module is configured to provide at least one of a username and a validated secure identity token to the user thereby allowing the user to continue as an authenticated user with the said username, at the occurrence of the merchant's website supporting social login corresponding to the user.

6. The system as claimed in claim 4 wherein the delegated identity propagation module is configured to provide an authenticated session token for the transaction to the user in response to the user using a one time passcode thereby discarding the requirement of the user to remember one or more passwords across one or more merchant website's, at the occurrence of the user shopping from the source app.

7. The system as claimed in claim 1 wherein the desirable payment method to the user is determined based on a success rate of previous payments made by the user and the previously used payment method of the user.

8. The system as claimed in claim 1 wherein the payment module supports multiple payment methods to the user and allows the user to purchase an insurance, in response to the user purchasing the one or more products within the context of the source app.

9. The system as claimed in claim 1 comprising:
a loyalty module operatively coupled to the user information module and configured to:
accumulate loyalty points offered to the user by a plurality of merchant websites; and
allow the user to redeem the said loyalty points, upon accumulation, for subsequent payments.

10. The system as claimed in claim 1 comprising a seller integration module operatively coupled to the generating module and configured to:
automatically validate the merchant website and activate the checkout widget code template in response to successful validation;
automatically detect one or more changes on the merchant website to render the details of the one or more products corresponding to the one or more changes; and
integrate seamlessly with the checkout capabilities of the merchant website.

11. The system as claimed in claim 1 wherein the seller integration module is configured to activate and deactivate a self-healing process in occurrence of an error in the merchant website.

12. The system as claimed in claim 1 comprising a database to store information of the user wherein the information is pre-populated in the checkout token based on the context.

13. The system as claimed in claim 1 comprising:
a tracking module configured to track an order placed by the user.

14. The system as claimed in claim 1 comprising:
a catalog synchronization module configured to fetch content, inventory and pricing of the products displayed to the user.

15. The system as claimed in claim 1 wherein the details of the one or more products is rendered to the user and subsequently the user is allowed to visit a corresponding merchant website.

16. The system as claimed in claim 1 wherein the user is rendered with a plurality of browsing features to confine the user to pay attention to a pre-defined number of products to purchase.

17. The system as claimed in claim 16 wherein the plurality of browsing features comprises a micro browse adapted to display at least four products to the user thereby increasing the probability of the user purchasing at least one of the four products, a mini browse adapted to display at least a hundred products thereby allowing the user to browse in a single catalog and transact within the said hundred products and a maxi browse adapted to transit the user to the merchant website thereby allowing the user to browse and purchase desired products directly from the said merchant website.

18. The system as claimed in claim 1 wherein the checkout button is adapted to change based on the context of the source app.

19. A computer-implemented method to dynamically inject multiple checkout capabilities comprising:
providing, by a redirecting module of a processing subsystem, one of a first checkout path and a second checkout path to a user, in response to the user clicking on an advertisement displayed in a source app wherein,
the first checkout path is adapted to enable the user to configure one or more options for one or more products and purchase the one or more products within the context of the advertisement or an offer displayed in the source app; and
the second checkout path is adapted to redirect the user to a merchant's website and allow the user to view one or more products prior to the purchase of the said one or more products,
wherein the second checkout path is within one of the context of the advertisement displayed in the source app and within the context of the source app;
injecting, by a generating module of the processing subsystem, dynamically inject a checkout widget code template which is templatized based on the context of the source app, user and merchant's website for a streamlined checkout experience in response to the user accessing the cart page wherein the checkout widget code template replaces an existing checkout experience seamlessly;
displaying, by a rendering module of the processing subsystem, a checkout page based on the context provided by the source app in response to the user selecting the checkout button integrated with the checkout widget code template, wherein the checkout page displays user information that is pre-filled thereby providing a speedy checkout experience to the user;
fetching, by an intelligent coupon code of the processing subsystem, desirable discount for the one or more products and automatically apply the desirable discount to a metadata corresponding to a profile of the user; and
determining and displaying, by a payment module of the processing subsystem, a desirable payment method to the user automatically to complete the purchase of the one or more products in the merchant website wherein the desirable payment method provides additional benefits as part of the purchase to the user.

20. The computer-implemented method as claimed in claim 19 comprising displaying an order confirmation page from the merchant website subsequent to an order is placed to purchase the one or more products by transmitting user details to the order confirmation page.

21. A non-transitory computer-readable medium storing a computer program that, when executed by a processor, causes the processor to perform a method to dynamically inject multiple checkout capabilities, wherein the method comprises:
providing, by a redirecting module of a processing subsystem, one of a first checkout path and a second checkout path to a user, in response to the user clicking on an advertisement displayed in a source app wherein,
the first checkout path is adapted to enable the user to configure one or more options for one or more products and purchase the one or more products within the context of the advertisement or an offer displayed in the source app; and
the second checkout path is adapted to redirect the user to a merchant's website and allow the user to view one or more products prior to the purchase of the said one or more products,
wherein the second checkout path is within one of the context of the advertisement displayed in the source app and within the context of the source app;
injecting, by a generating module of the processing subsystem, dynamically inject a checkout widget code template which is templatized based on the context of the source app, user and merchant's website for a streamlined checkout experience in response to the user accessing the cart page wherein the checkout widget code template replaces an existing checkout experience seamlessly:
displaying, by a rendering module of the processing subsystem, a checkout page based on the context provided by the source app in response to the user selecting the checkout button integrated with the checkout widget code template, wherein the checkout page displays user information that is pre-filled thereby providing a speedy checkout experience to the user;
fetching, by an intelligent coupon code of the processing subsystem, desirable discount for the one or more products and automatically apply the desirable discount to a metadata corresponding to a profile of the user; and
determining and displaying, by a payment module of the processing subsystem, a desirable payment method to the user automatically to complete the purchase of the one or more products in the merchant website wherein the desirable payment method provides additional benefits as part of the purchase to the user.

22. The computer-readable medium as claimed in claim 21 comprising displaying an order confirmation page from the merchant website subsequent to an order is placed to purchase the one or more products by transmitting user details to the order confirmation page.
